(19) United States
(12) Patent Application Publication
(10) Pub. No.: US 2013/0143002 A1
(43) Pub. Date: Jun. 6, 2013

(54) METHOD AND SYSTEM FOR OPTICAL CALLIBRATION DISCS

(71) Applicants: Nobuo Kurataka, Campbell, CA (US); Gennady Gauzner, San Jose, CA (US); Zhaoning Yu, Palo Alto, CA (US)

(72) Inventors: Nobuo Kurataka, Campbell, CA (US); Gennady Gauzner, San Jose, CA (US); Zhaoning Yu, Palo Alto, CA (US)

(73) Assignee: SEAGATE TECHNOLOGY LLC, Cupertino, CA (US)

(21) Appl. No.: 13/311,302

(22) Filed: Dec. 5, 2011

(51) Int. Cl. B32B 3/10; C23F 1/04; B05D 3/06; B05D 5/00

(52) U.S. Cl. 428/172; 427/256; 216/41; 427/558; 427/553

(57) ABSTRACT

A system and method for optical calibration discs includes dispensing a resist layer on a portion of a substrate. A surface of the substrate and a topographically patterned surface of predetermined objects of a template are contacted together, wherein the contacting causes the resist layer between the portion of the substrate and the template to conform to the topographically patterned surface, and the resist layer includes nano-scale voids. The nano-scale voids are reduced by longer spread time, thinner resist, and removal of the residual resist layer together with the voids by using a descum step. The resist layer is hardened into a negative image of the topographically patterned surface, wherein the negative image includes surfaces that are operable to be individually measured by an optical reader. The substrate and the template are separated, wherein the resist layer adheres to the surface of the substrate.

### FIELD

Embodiments according to the present invention generally relate to calibration equipment including bit patterned media technology.

### BACKGROUND

In magnetic recording media, information is written to and read from a recording medium. For example, disk drives may include one or more hard disks, which may be fabricated on production lines.

A hard disk is an apparatus including multiple layers established upon a substrate. For example, a seed layer may be established overlying the substrate. A base layer may be established overlying the seed layer. Perpendicular magnetic recording islands are recording areas that may be established in the base layer and on the seed layer.

Optical inspection tools are used for media production. For example, optical recognition and measuring tools may monitor processes and defect control of hard disk fabrication. The optical inspection tools optically examine a surface, for example the surface of the hard disk, after each process step. However, prior to monitoring the hard disk fabrication, the optical inspection tools may need to be reliably and accurately calibrated.

### BRIEF DESCRIPTION OF THE DRAWINGS

Embodiments of the present invention are illustrated by way of example, and not by way of limitation, in the figures of the accompanying drawings.

FIG. 1 is a simplified cross-sectional view of the fabrication of a portion of a calibration disc, according to an embodiment of the present invention.

FIG. 2 is a simplified cross-sectional view of the fabrication of a portion of the calibration disc after a template has been brought into contact with resist drops, according to an embodiment of the present invention.

FIG. 3 is a simplified cross-sectional view of the fabrication of a portion of the calibration disc after the resist layer has been cured, according to an embodiment of the present invention.

FIG. 4 is a simplified cross-sectional view of the fabrication of a portion of the calibration disc after a removal process, according to an embodiment of the present invention.

FIG. 5 is a simplified cross-sectional view of the fabrication of a portion of the calibration disc including a protective overcoat, according to an embodiment of the present invention.

FIG. 6 is a simplified view of a magnified portion of the surface of a calibration disc including a pattern of voids.

FIG. 7 is a simplified view of a portion of a resist bump pattern, according to an embodiment of the present invention.

FIG. 8 is a simplified view of the surface of the calibration disc, according to an embodiment of the present invention.

FIG. 9 is a simplified cross-sectional view of the calibration disc and optical measuring equipment, according to an embodiment of the present invention.

FIG. 10 depicts a flowchart of a process of forming a calibration disc, according to some embodiments of the present invention.

FIG. 11 depicts a flowchart of a process of forming a calibration tool, according to some embodiments of the present invention.

### DETAILED DESCRIPTION

Reference will now be made in detail to embodiments, examples of which are illustrated in the accompanying drawings. While the embodiments will be described in conjunction with the drawings, it will be understood that they are not intended to limit the embodiments. On the contrary, the embodiments are intended to cover alternatives, modifications and equivalents. Furthermore, in the following detailed description, numerous specific details are set forth in order to provide a thorough understanding. However, it will be recognized by one of ordinary skill in the art that the embodiments may be practiced without these specific details. In other instances, well-known methods, procedures, components, and circuits have not been described in detail as not to unnecessarily obscure aspects of the embodiments.

For expository purposes, the term “horizontal” as used herein refers to a plane parallel to the plane or surface of a substrate, regardless of its orientation. The term “vertical” refers to a direction perpendicular to the horizontal as just defined. Terms such as “above,” “below,” “bottom,” “top,” “side,” “higher,” “lower,” “upper,” “over,” and “under” are referred to with respect to the horizontal plane.

Embodiments of the present invention provide methods and systems for calibrating optical measuring equipment, for example Candela tools, used, for instance, in the fabrication of recording media. However, embodiments of the present invention can be applied to any optical inspection tool that requires calibration. In an embodiment, bit patterned media (“BPM”) fabrication techniques and imprint lithography may be used to create calibration apparatuses, for example calibration discs. The BPM calibration discs may be used to calibrate a number of Candela tools. For example, the Candelas may optically read a known predetermined predictable pattern that has been formed on the BPM calibration discs. The results of the readings are then used to calibrate the Candela equipment.

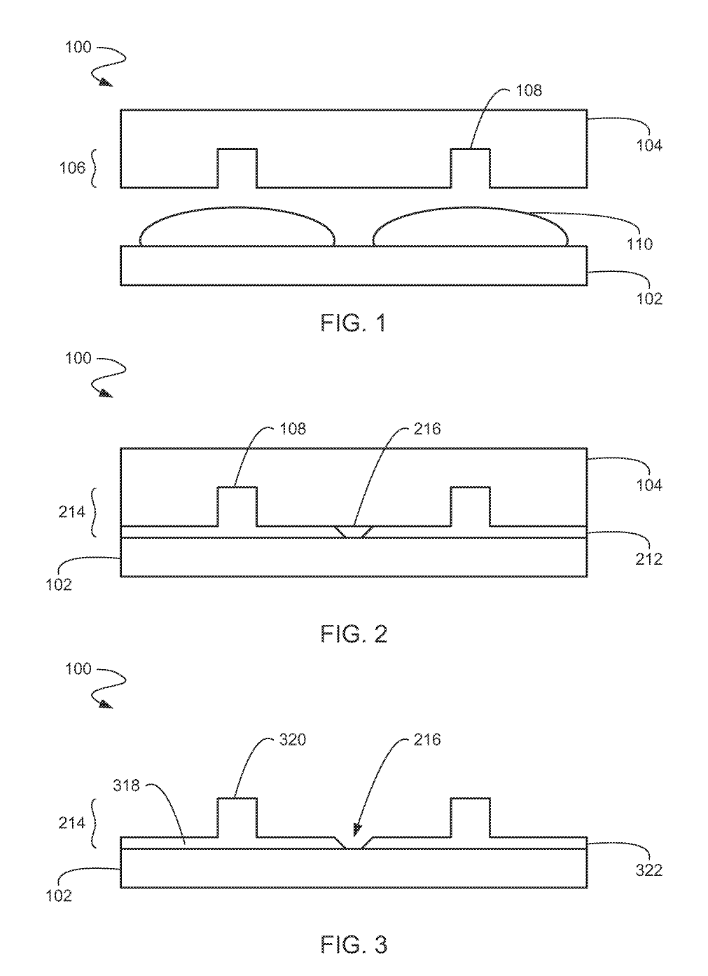

FIG. 1 is a simplified cross-sectional view of the fabrication of a portion of a calibration disc 100, according to an embodiment of the present invention. The calibration disc 100 includes a substrate 102. In an embodiment, the substrate 102 may be, for example, an aluminum or glass disc, a Si wafer, or other wafer material (for example glass discs 65 mm in diameter, including a 20 mm hole). A template 104 is positioned above the substrate 102. The template 104 includes a predetermined pattern 106. In some embodiments, the predetermined pattern 106 includes bands of holes 108 of various sizes.

Resist drops 110 may be deposited on the substrate 102, for example by drop-and-dispense methods. In some embodiments the resist drops 110 may be deposited with about 4-6 pL in drop volume and at about 100-500 μm in spacing between drops. Together with the substrate 102 and the template 104, the resist drops 110 are used in patterning steps based on drop-and-dispense UV-cure nanoimprint lithography (see below).

FIG. 2 is a simplified cross-sectional view of the fabrication of a portion of the calibration disc 100 after further processing, according to an embodiment of the present invention. The template 104 has been brought into contact with the resist drops 110 (FIG. 1). The template 104 causes the resist drops 110 (FIG. 1) to spread, thus forming a resist layer 212. During an imprint spread time (defined as the time between when the template starts to contact the resist and when UV-irradiation is applied to cure the resist), the resist layer 212 spreads across the template 104 and the substrate 102. The resist layer 212 fills the bands of holes 108, forming a resist pattern 214. In an embodiment, the resist pattern 214 is a negative image of the predetermined pattern 106 (FIG. 1).

In some embodiments, a series of voids 216, e.g. nano-scale voids, are formed in the resist layer 212 at the boundaries between the resist drops 110 (FIG. 1) after spreading. For example, the voids 216 may be about 50-5000 nm in size, and may be formed as the result of gas bubbles that are trapped due to incomplete absorption of gas molecules by the resist layer 212 and the substrate 102. It is appreciated, in order to decrease the numbers and sizes of the voids 216 and increase the elimination of the voids 216, the imprint spread time may be significantly increased over conventional spread times and a significantly thinner resist may be used.

For example, the imprint spread time may be increased to about 2 to 10 minutes before UV-light irradiation. In addition the resist layer 212 may be about 10 nm in equivalent thickness, e.g. the average thickness of the resist layer 212. In addition, this process may cause the resist pattern 214 to have a very thin, e.g. less than 10 nm, residual resist layer 318 (see FIG. 3) compared to resist bumps 320 (see FIG. 3). Thus, as a result of the increased spread time and the very thin residual resist layer 318, the voids 216 are significantly reduced and/or eliminated.

FIG. 3 is a simplified cross-sectional view of the fabrication of a portion of the calibration disc 100 after further processing, according to an embodiment of the present invention. The resist layer 212 (FIG. 2) has been fortified (e.g. cured), for example by UV-light irradiation, and has hardened and solidified into a rigid resist layer 322. The rigid resist layer 322 includes the very thin residual resist layer 318, the voids 216, and the resist bumps 320. The template 104 (FIG. 2) has been separated from the rigid resist layer 322 and the substrate 102, leaving the rigid resist layer 322 including the resist pattern 214 attached to the substrate 102.

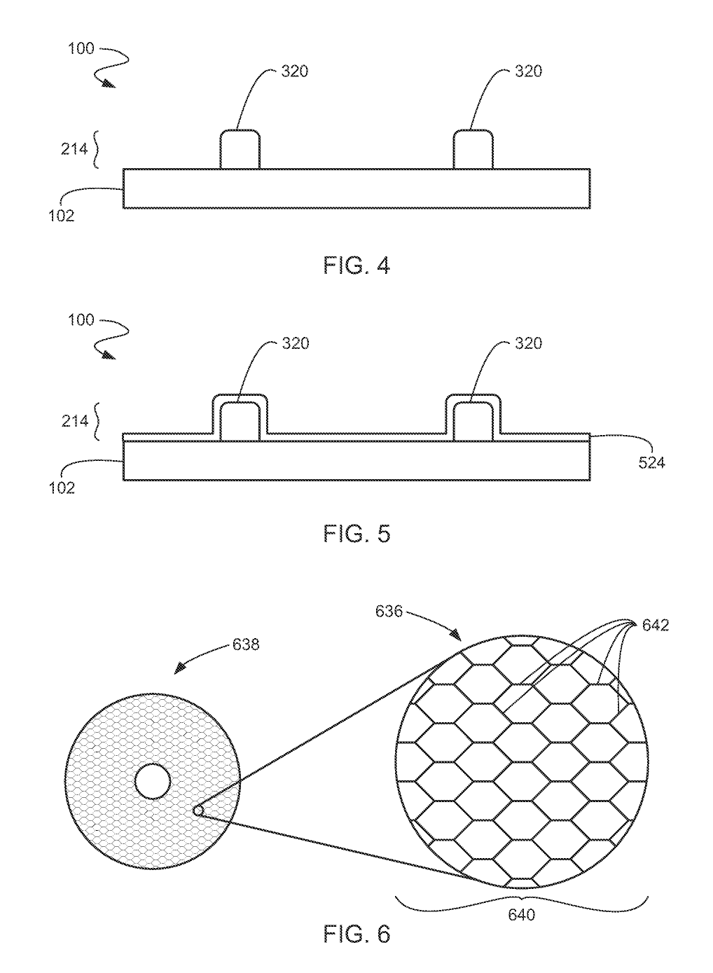

FIG. 4 is a simplified cross-sectional view of the fabrication of a portion of the calibration disc 100 after further processing, according to an embodiment of the present invention. A removal process, e.g. an etched based de-scum, may remove the very thin residual resist layer 318 and the voids 216. Thus, the substrate 102 and the resist bumps 320 remain. In an embodiment, the resist bumps 320 are mostly unaffected by the removal process. Thus, a predetermined predictable pattern of the resist bumps 320 may be substantially free of the voids 216.

For example, an O₂ reactive ion etch based de-scum step may be used to remove the very thin residual resist layer 318. As a result, the voids 216 within the very thin residual resist layer 318 are also removed. In some embodiments, the resist bumps 320 are sparsely spaced and are much thicker than the very thin residual resist layer 318. Therefore, the resist bumps 320 may be only slightly affected by the O₂ reactive ion etch based de-scum step.

In some embodiments, the very thin residual resist layer 318 may not be uniform. For example, the very thin residual resist layer 318 may have a thickness across the substrate 102 that varies between about 1-20 nm. Therefore, the removal process may form a uniform layer between the resist bumps 320 by removing the unevenness in the very thin residual resist layer 318.

FIG. 5 is a simplified cross-sectional view of the fabrication of a portion of the calibration disc 100 after further processing, according to an embodiment of the present invention. In some embodiments, a protective overcoat 524 may be deposited on the substrate 102 and the resist bumps 320. For example, a protective carbon overcoat, about 5 nm thick, may be sputter deposited on the substrate and the resist bumps 320.

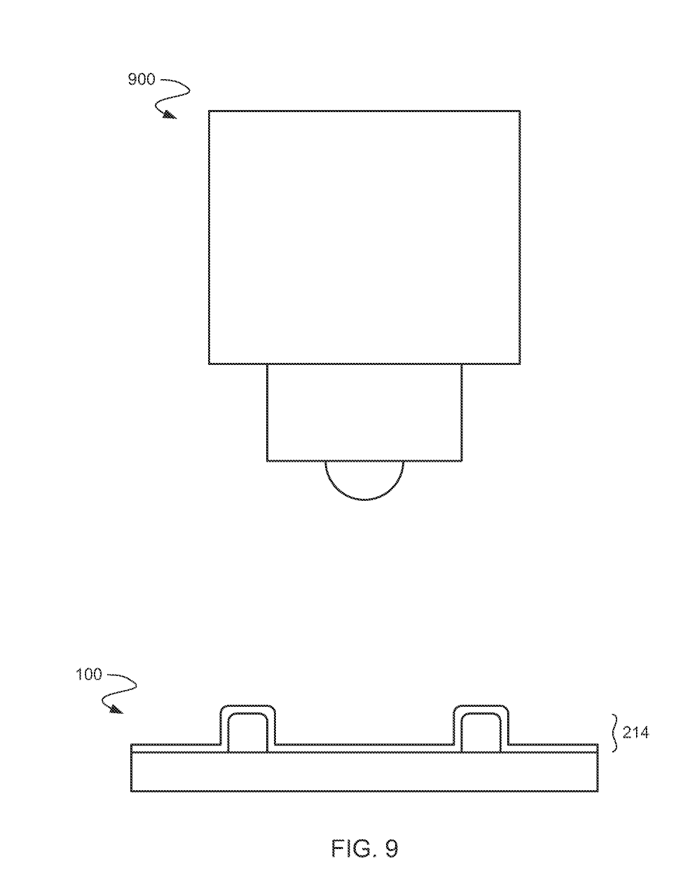

FIG. 6 is a simplified view of a magnified portion 636 of the surface of a calibration disc 638 including a pattern 640 of voids 642. As described above, the voids 642 may form at the boundaries of resist drops as they spread together during imprinting. The voids 642 thus form the pattern 640, sometimes referred to as a “fishnet” pattern, on the surface of the calibration disc 638. In some embodiments, the pattern 640 may interfere with the calibration of optical measuring equipment 900 (see FIG. 9). Thus, the processes described above for reduction and or removal of the voids 642 may also result in the removal of the pattern 640.

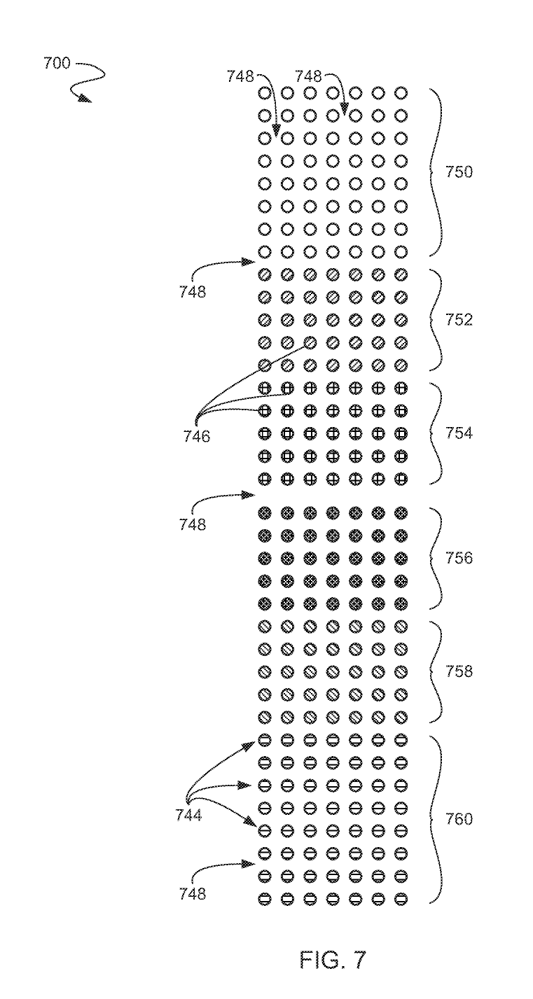

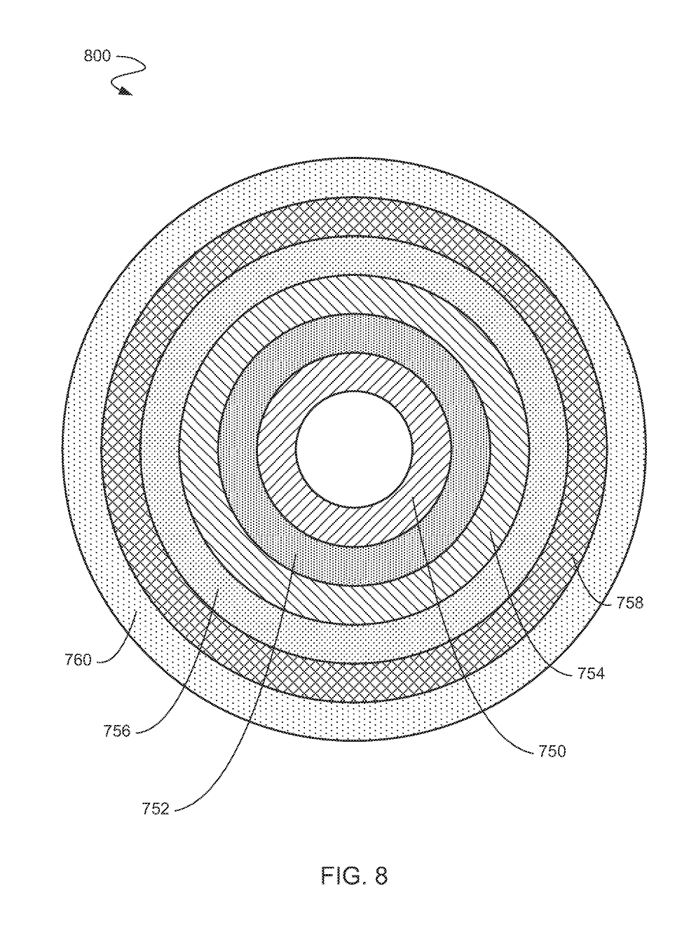

FIG. 7 is a simplified view of a portion of a resist bump pattern 700, according to an embodiment of the present invention. In an embodiment, rows 744 of sparsely spaced bumps 746 may be arranged on a calibration disc 800 (FIG. 8). The bumps 746 may be arranged in a known pattern with known spacing 748 between the bumps 746. In addition, the size of the bumps 746 may be known, and may form a substantially continuous predetermined predictable pattern.

For example, a first group 750 of the bumps 746 may include eight rows of 1000 nm bumps with a 100 μm bump to bump spacing. A second group 752 of the bumps 746 may include five rows of 700 nm bumps with a 100 μm bump to bump spacing. A third group 754 of the bumps 746 may include five rows of 400 nm bumps with a 100 μm bump to bump spacing. A fourth group 756 of the bumps 746 may include five rows of 200 nm bumps with a 100 μm bump to bump spacing. In addition, there may be a 150 μm spacing between the third group 754 and the fourth group 756. A fifth group 758 of the bumps 746 may include five rows of 80 nm bumps with a 100 μm bump to bump spacing. A sixth group 760 of the bumps 746 may include eight rows of 50 nm bumps with a 100 μm bump to bump spacing.

In various embodiments, any number of known groups, bumps, and/or rows may be used and separated by any known space size, thus forming known patterns on a calibration disc. Optical measuring equipment may measure the known patterns and compare the measurements to the known values. As a result, the optical measuring equipment may be calibrated to correctly measure the known patterns. Furthermore, the groups of differently sized bumps on the single calibration disc, decreases the time needed to calibrate the optical measuring equipment.

For example, a first predetermined predictable pattern including first bumps, e.g. first group 750, on a portion of a substrate and a second predetermined predictable pattern of second resist bumps, e.g. second group 752, on a different portion of the same substrate may be operable to be measured by a recording surface optical reader, e.g. optical measuring equipment (See FIG. 9). Furthermore, the first and second predetermined predictable patterns may include substantially continuous areas between their respective bumps. For instance, the bumps may have a 100 μm bump to bump spacing, a 100 μm spacing between groups, or a 150 μm spacing between groups.

FIG. 8 is a simplified view of the surface of the calibration disc 800, according to an embodiment of the present invention. In an embodiment, the groups and rows of the bumps 746 (FIG. 7) may be arranged at known radii across the calibration disk 800. Thus, the first group 750 may be at inner radii of the calibration disc 800. The second group 752 may be at outer radii relative to the first group 750. The third group 754 may be at outer radii relative to the second group 752. The fourth group 756 may be at outer radii relative to the third group 754. The fifth group 758 may be at outer radii relative to the fourth group 756. The sixth group 760 may be at outer radii relative to the fifth group 758. In various embodiments, any number of groups may be positioned in any known arrangement across the calibration disc 800.

FIG. 9 is a simplified cross-sectional view of the calibration disc 100 and optical measuring equipment 900, according to an embodiment of the present invention. In an embodiment the optical measuring equipment 900 may be a recording surface optical reader, e.g. a Candela tool, that optically read the resist pattern 214 on the calibration disc 100. For example, a Candela tool may direct multiple (e.g. one, two, three, etc.) laser beams onto a disc surface, and a number of detectors take a number of signal readings. Thus, the calibration disc 100 may be used to calibrate scattered channel sensitivity to different “particle” sizes.

Because the resist pattern 214 is already known prior to the optical measuring equipment 900 imaging the calibration disc 100, the readings taken by the optical measuring equipment 900 may be compared to the resist pattern 214. Adjustments may then be made to the optical measuring equipment 900 for calibration. In some embodiments, the readings from a number of Candela may be used to calibrate the Candela to each other.

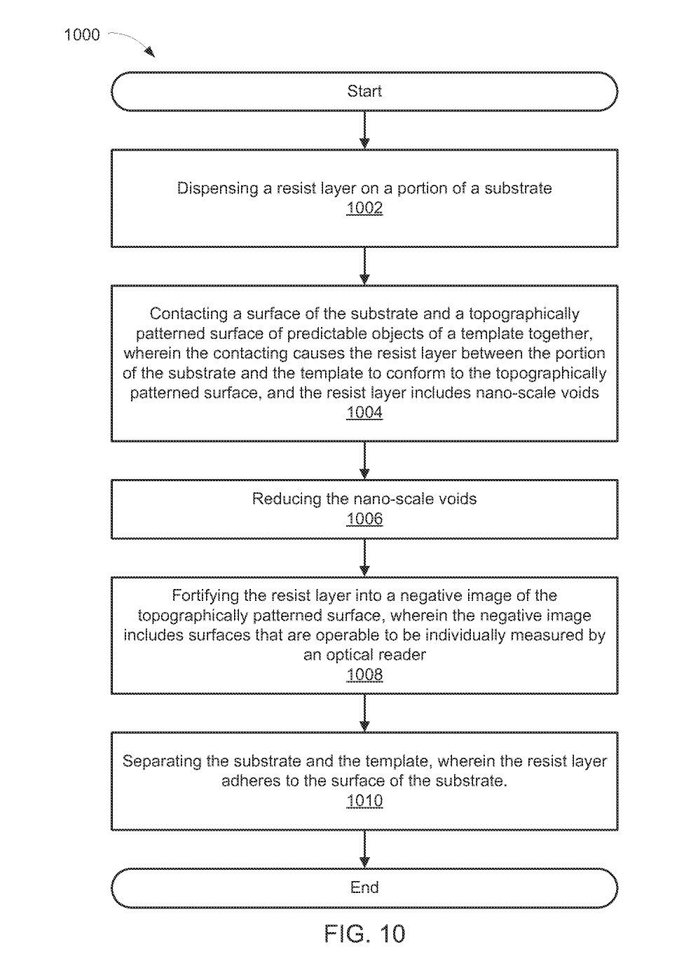

FIG. 10 depicts a flowchart 1000 of an exemplary process of forming a calibration disc, according to some embodiments of the present invention. In block 1002, a resist layer is dispensed on a portion of a substrate. In some embodiments, dispensing the resist layer includes drop-dispensing the resist layer. For example, in FIG. 1 the resist drops may be deposited on the substrate, e.g. by drop-and-dispense methods. The resist drops may be deposited with about 4-6 pL in drop volume and at about 100-500 μm in spacing between drops.

In block 1004 of FIG. 10, a surface of the substrate and a topographically patterned surface of predetermined predictable objects of a template are contacted together, wherein the contacting causes the resist layer between the portion of the substrate and the template to conform to the topographically patterned surface, and wherein the resist layer comprises nano-scale voids. For example, in FIG. 2 the template has been brought into contact with the resist drops. The template causes the resist drops to spread, thus forming a resist layer. The resist layer spreads across the template and the substrate, filling the bands of holes and forming a resist pattern. A series of voids, e.g. nano-scale voids, are formed in the resist layer at the boundaries between the resist drops after spreading. The voids may be about 100-300 nm in size, and may be formed as the result of gas bubbles that are trapped due to incomplete absorption of gas molecules by the resist layer and the substrate.

In some embodiments, the resist layer includes a residual resist layer, and the residual resist layer includes the nano-scale voids. For example, in FIG. 3 the rigid resist layer includes the very thin residual resist layer, the voids, and the resist bumps. In further embodiments, the process may include removing the residual resist layer. For example, in FIG. 4 the removal process, e.g. an etch based de-scum, may remove the very thin residual resist layer and the voids.

In block 1006 of FIG. 10, the nano-scale voids are reduced. In some embodiments, the reducing includes substantially removing the nano-scale voids. For example, in FIG. 2 the imprint spread time may be increased. In another example, in FIG. 4 a removal process may remove the very thin residual resist layer and the voids.

In various embodiments, the reducing includes a reactive ion etch based de-scum operation. For example, in FIG. 4 a removal process, e.g. an etched based de-scum, may remove the very thin residual resist layer and the voids. Thus, the substrate and the resist bumps remain. The resist bumps may be mostly unaffected by the removal process.

In further embodiments, the reducing includes waiting for an imprint spread time to substantially remove the nano-scale voids before fortifying the resist layer. For example, in FIG. 2 the imprint spread time may be significantly increased over conventional spread times. For instance, the imprint spread time may be increased to about 2 to 10 minutes before UV-light irradiation.

In block 1008 of FIG. 10, the resist layer is hardened into a negative image of the topographically patterned surface, wherein the negative image includes surfaces that are operable to be individually measured by an optical reader. In some embodiments, the fortifying includes curing the resist layer with UV light irradiation. For example, in FIG. 3 the resist layer has been cured, for example by UV light irradiation, and has solidified into a rigid resist layer. Furthermore, in FIG. 9 the optical measuring equipment may be Candela that optically read the resist pattern on the calibration disc.

In block 1010 of FIG. 10, the substrate and the template are separated, wherein the resist layer adheres to the surface of the substrate. For example, in FIG. 3 the template has been separated from the rigid resist layer and the substrate, leaving the rigid resist layer including the resist pattern attached to the substrate. In further embodiments, a protective overcoat is deposited on the resist layer. For example, in FIG. 5 the protective overcoat may be deposited on the substrate and the resist bumps. For instance, a protective carbon overcoat, about 5 nm thick, may be sputter deposited on the substrate and the resist bumps.

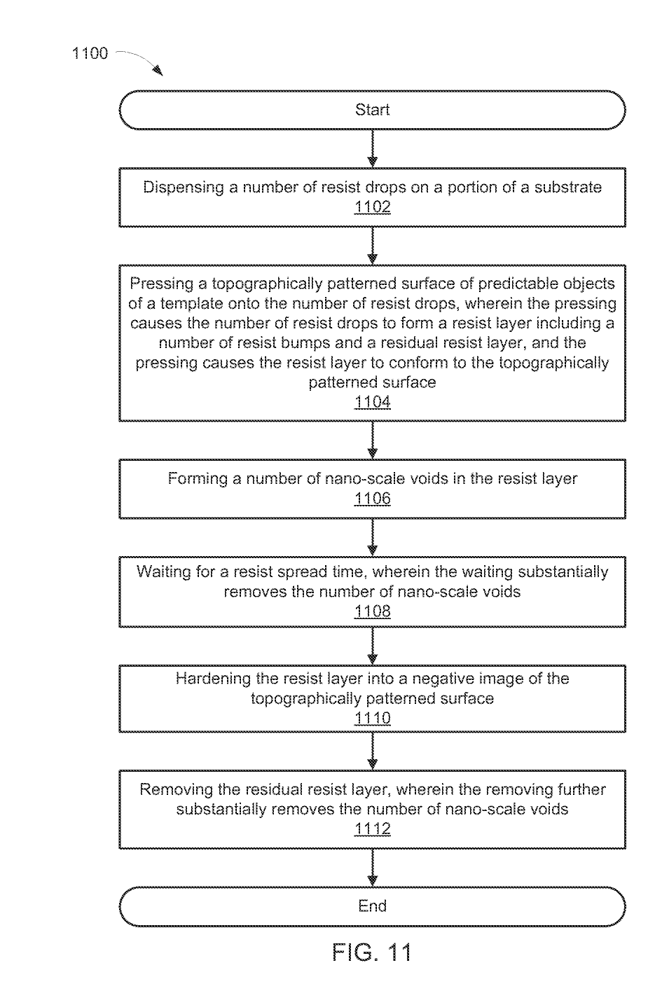

FIG. 11 depicts a flowchart 1100 of an exemplary process of forming a calibration tool, according to some embodiments of the present invention. In a block 1102, a number of resist drops are dispensed on a portion of a substrate. In some embodiments, the dispensing includes drop dispensing the resist drops. For example, in FIG. 1 the resist drops may be deposited on the substrate, e.g. by drop-and-dispense methods. The resist drops may be deposited with about 4-6 pL in drop volume and at about 100-500 μm in spacing between drops.

In a block 1104 of FIG. 11, a topographically patterned surface of predetermined predictable objects of a template is pressed onto the number of resist drops, wherein the pressing causes the number of resist drops to form a resist layer including a number of resist bumps and a residual resist layer, and wherein the pressing causes the resist layer to conform to the topographically patterned surface. For example, in FIG. 2 the template has been brought into contact with the resist drops. The template causes the resist drops to spread, thus forming a resist layer. The resist layer spreads across the template and the substrate, filling the bands of holes and forming a resist pattern.

In various embodiments the residual resist layer is less than 10 nm thick. For example, in FIG. 2 the resist layer may be about 10 nm in equivalent thickness, e.g. the average thickness of the resist layer. In addition, the resist pattern may have a very thin, e.g. less than 10 nm, residual resist layer (FIG. 3) compared to resist bumps (FIG. 3).

In some embodiments, the resist bumps are about 50 nm to about 1000 nm in size. For example, in FIG. 7 a first group of the bumps may include eight rows of 1000 nm bumps. A second group of the bumps may include five rows of 700 nm bumps. A third group of the bumps may include five rows of 400 nm bumps. A fourth group of the bumps may include five rows of 200 nm bumps. A fifth group of the bumps may include five rows of 80 nm bumps. A sixth group of the bumps may include eight rows of 50 nm bumps.

In a block 1106 of FIG. 11, a number of nano-scale voids are formed in the resist layer. For example, in FIG. 2 a series of voids, e.g. nano-scale voids, are formed in the resist layer at the boundaries between the resist drops after spreading. The voids may be about 100-300 nm in size, and may be formed as the result of gas bubbles that are trapped due to incomplete absorption of gas molecules by the resist layer and the substrate.

In a block 1008 of FIG. 11, waiting for a resist spread time, wherein the waiting substantially removes the plurality of nano-scale voids. In various embodiments, the resist spread time may be between 2 and 10 minutes in length. For example, in FIG. 2 the imprint spread time may be significantly increased over conventional spread times. For instance, the imprint spread time may be increased to about 2 to 10 minutes before UV-light irradiation. Thus, as a result of the increased spread time, the voids are significantly reduced and/or eliminated.

In a block 1110 of FIG. 11, the resist layer is hardened into a negative image of the topographically patterned surface. In some embodiments, the hardening includes using light irradiation to solidify the resist layer. For example, in FIG. 3 the resist layer has been cured, for example by UV light irradiation, and has solidified into a rigid resist layer. The resist pattern may be a negative image of the predetermined pattern (FIG. 1).

In a block 1112 of FIG. 11, the residual resist layer is removed, wherein the removing further substantially removes the number of nano-scale voids. In further embodiments, the removing includes an O2 reactive ion etch based de-scum operation. For example, in FIG. 4 a removal process, e.g. an etch based de-scum, may remove the very thin residual resist layer and the voids. Thus, the substrate and the resist bumps remain. The resist bumps may be mostly unaffected by the removal process.

In further embodiments, a protective layer of carbon overcoat is deposited on the negative image. For example, in FIG. 5 the protective overcoat may be deposited on the substrate and the resist bumps. For instance, a protective carbon overcoat, about 5 nm thick, may be sputter deposited on the substrate and the resist bumps.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A method comprising:
dispensing a resist layer on a portion of a substrate;
contacting a surface of said substrate and a topographically patterned surface of predetermined objects of a template together, wherein
said contacting causes said resist layer between said portion of said substrate and said template to conform to said topographically patterned surface, and
said resist layer comprises nano-scale voids;
reducing said nano-scale voids;
fortifying said resist layer into a negative image of said topographically patterned surface, wherein said negative image comprises surfaces that are operable to be individually measured by an optical reader; and
separating said substrate and said template, wherein said resist layer adheres to said surface of said substrate.

2. The method of claim 1, wherein
said resist layer comprises a residual resist layer, and
said residual resist layer comprises said nano-scale voids; and further comprising removing said residual resist layer.

3. The method of claim 1 wherein said reducing comprises substantially removing said nano-scale voids.

4. The method of claim 1 wherein said reducing comprises a reactive ion etch based de-scum operation.

5. The method of claim 1 wherein said reducing comprises waiting for an imprint spread time to substantially remove said nano-scale voids before said fortifying.

6. The method of claim 1 wherein said dispensing said resist layer comprises drop-dispensing said resist layer.

7. The method of claim 1 wherein said fortifying comprises curing said resist layer with UV light irradiation.

8. The method of claim 1 further comprising depositing a protective overcoat on said resist layer.

9. A method comprising:
dispensing a plurality of resist drops on a portion of a substrate;
pressing a topographically patterned surface of predictable objects of a template onto said plurality of resist drops, wherein
said pressing causes said plurality of resist drops to form a resist layer comprising a plurality of resist bumps and a residual resist layer, and
said pressing causes said resist layer to conform to said topographically patterned surface;
forming a plurality of nano-scale voids in said resist layer;
waiting for a resist spread time, wherein said waiting substantially removes said plurality of nano-scale voids;
hardening said resist layer into a negative image of said topographically patterned surface; and
removing said residual resist layer, wherein said removing further substantially removes said plurality of nano-scale voids.

10. The method of claim 9 wherein said removing comprises an O₂ reactive ion etch based de-scum operation.

11. The method of claim 9, wherein
said resist bumps are about 50 nm to about 1000 nm in size,
said dispensing comprises drop dispensing said resist drops, and
said resist spread time is between 2 and 10 minutes in length.

12. The method of claim 9 wherein said residual resist layer is less than 10 nm thick.

13. The method of claim 9, wherein said hardening comprises using light irradiation to solidify said resist layer.

14. The method of claim 9, further comprising depositing a protective layer of carbon overcoat on said negative image.

15. An apparatus comprising:
a substrate;
a first predetermined predictable pattern comprising first resist bumps on a portion of said substrate, wherein
said first predetermined predictable pattern is substantially continuous between said first resist bumps, and
said first predetermined predictable pattern is operable to measured by a recording surface optical reader; and
a protective overcoat on said first resist bumps and said substrate.

16. The apparatus of claim 15 wherein said first predetermined predictable pattern is substantially free of nano-voids.

17. The apparatus of claim 15 wherein said recording surface optical reader is a Candela tool.

18. The apparatus of claim 15 wherein said protective overcoat is a carbon overcoat.

19. The apparatus of claim 15, wherein
said first predetermined pattern further comprises an area between said first resist bumps; and
a thickness of said area is substantially continuous.

20. The apparatus of claim 15:
further comprising, a second predetermined predictable pattern of second resist bumps on a different portion of said substrate,
wherein said second predetermined predictable pattern is operable to be measured by said recording surface optical reader.
